(19) United States
(12) Patent Application Publication
(10) Pub. No.: US 2012/0161090 A1
(43) Pub. Date: Jun. 28, 2012

(54) RUTILE-TYPE TITANIUM OXIDE CRYSTAL AND MID-INFRARED FILTER USING THE SAME

(75) Inventors: Pei-Xin Zhu, Sakura-shi (JP); Ren-Hua Jin, Sakura-shi (JP)

(73) Assignees: KAWAMURA INSTITUTE OF CHEMICAL RESEARCH, Sakura-shi (JP); DIC CORPORATION, Tokyo (JP)

(21) Appl. No.: 13/322,346

(22) PCT Filed: May 24, 2010
(86) PCT No.: PCT/JP2010/058709

§ 371 Date: Mar. 20, 2012

(30) Foreign Application Priority Data
Jun. 1, 2009 (JP) 2009-132024

(51) Int. Cl. G02B 5/20

(52) U.S. Cl. 252/587

(57) ABSTRACT

A highly versatile material for mid-infrared filters is provided by precisely controlling the absorption intensity of titanium oxide in an infrared region. A rutile-type titanium oxide crystal is produced by a method including a step (I) of dispersing or dissolving a complex of an amino group-containing basic polymer and a transition metal ion in an aqueous medium, a step (II) of obtaining a composite having a polymer/titania layered structure in which the complex of the amino group-containing basic polymer and the transition metal ion is sandwiched between layers of titania, by causing a hydrolysis reaction between the aqueous dispersion or aqueous solution prepared in the step (I) and a water-soluble titanium compound in the aqueous medium, and a step (III) of calcining the composite having the layered structure in an air atmosphere at a temperature of 650° C. or higher to dope a surface of a titanium oxide crystal with the transition metal ion and simultaneously to cause growth into a rutile-type crystal phase. The thus-obtained crystal can be used for mid-infrared filters.

### TECHNICAL FIELD

The present invention relates to a rutile-type titanium oxide crystal that can efficiently transmit mid-infrared rays, a method for producing the rutile-type titanium oxide crystal, a molding material for mid-infrared filters that uses the rutile-type titanium oxide crystal, and a mid-infrared filter obtained by molding the molding material.

### BACKGROUND ART

Infrared filters are materials that are widely used in industries, particularly for optical devices (cameras, microscopes, displays). There are many types of infrared filters, but most of them are near-infrared filters and there are not so many materials and filters that can transmit mid-infrared rays. That is, the materials that can be used for transmitting mid-infrared rays are materials obtained by forming a multi-layer film on an optical substrate for infrared rays composed of, for example, quartz, sapphire, or silicon by metal deposition or the like. In such materials, the infrared transmitting property is controlled using the effect of the interference film. However, the production cost is high and thus the versatility is poor.

If a wavelength range in which no infrared absorption occurs can be controlled by using a compound that absorbs infrared rays, such a method is more economical than the method using an interference film. From such a viewpoint, it is known that, by using a noble metal oxide having a nanostructure, the infrared absorption range is controlled to transmit infrared rays having particular wavelengths. For example, by using a manganese oxide-based nano-porous crystal, infrared rays having particular wavelengths can be transmitted (e.g., refer to PTL 1). However, such a method that uses a noble metal oxide requires high production cost due to the raw material cost, thereby having no versatility as an industrial method.

The titanium oxide reserves in nature are larger than the reserves of noble metal oxides, and titanium oxide is a cheap material that is widely used in industries from those concerning general-purpose materials such as white pigment, photocatalysts, and paint to those concerning special fields of application such as dye-sensitized solar cells and light-responsive materials. Titanium oxide itself can absorb a certain amount of infrared rays in near-infrared and far-infrared regions. However, since the infrared absorption is not selective, titanium oxide transmits infrared rays with a wide range of wavelengths from the near-infrared region to the mid-infrared region, and therefore has no wavelength selectivity in absorption and transmission. Therefore, titanium oxide itself cannot be used for infrared filters. It is believed that, if a method for precisely controlling the infrared absorption range intrinsic to titanium oxide is found, the versatility of, in particular, mid-infrared filters will be significantly increased.

### CITATION LIST

### Patent Literature

PTL 1: Japanese Unexamined Patent Application Publication No. 2007-238424

### SUMMARY OF INVENTION

### Technical Problem

In view of the foregoing, an object of the present invention is to provide a material for mid-infrared filters having high versatility by precisely controlling the absorption intensity of titanium oxide in an infrared region.

### Solution to Problem

As a result of eager study to achieve the object above, the inventors of the present invention have found that, by doping titanium oxide with a trace amount of transition metal ion and growing the doped titanium oxide into a rutile-type crystal, the absorption in near/far infrared regions, which is a property intrinsic to titanium oxide, is increased and thus a transmission wavelength region of mid-infrared rays can be significantly narrowed, whereby such a material can be suitably used as a material for mid-infrared filters. Thus, the inventors have completed the present invention.

The present invention provides a method for producing a rutile-type titanium oxide crystal doped with a transition metal ion, the method including:

a step (I) of dispersing or dissolving a complex (y) of an amino group-containing basic polymer (x) and a transition metal ion in an aqueous medium;

a step (II) of obtaining a composite having a polymer/titania layered structure in which the complex (y) of the amino group-containing basic polymer (x) and the transition metal ion is sandwiched between layers of titania with a distance of 1 to 3 nm, by mixing the aqueous dispersion or aqueous solution prepared in the step (I) with a water-soluble titanium compound (z) in the aqueous medium at a temperature of 50° C. or lower to cause a hydrolysis reaction; and

a step (III) of calcining the composite having the layered structure in an air atmosphere at a temperature of 650° C. or higher to dope a surface of a titanium oxide crystal with the transition metal ion confined in the layered structure and simultaneously to cause growth into a rutile-type crystal phase. The present invention also provides a rutile-type titanium oxide crystal that exhibits a transmitting property in a range of 5 to 12 μm of an infrared spectrum and whose half-width of a transmission peak is 2.5 μm or less.

The present invention also provides a powder for mid-infrared filters containing the rutile-type titanium oxide crystal.

The present invention also provides a method for producing a molding material for mid-infrared filters, the method including:

a step (I) of dispersing or dissolving a complex (y) of an amino group-containing basic polymer (x) and a transition metal ion in an aqueous medium;

a step (II) of obtaining a composite having a polymer/titania layered structure in which the complex (y) of the amino group-containing basic polymer (x) and the transition metal ion is sandwiched between layers of titania with a distance of 1 to 3 nm, by mixing the aqueous dispersion or aqueous solution prepared in the step (I) with a water-soluble titanium compound (z) in the aqueous medium at a temperature of 50° C. or lower to cause a hydrolysis reaction;

a step (III) of calcining the composite having the layered structure in an air atmosphere at a temperature of 650° C. or higher to dope a surface of a titanium oxide crystal with the transition metal ion confined in the layered structure and simultaneously to cause growth into a rutile-type crystal phase; and

a step (IV) of dispersing a rutile-type titanium oxide crystal obtained in the step (III) in a polyolefin. The present invention also provides a molding material for mid-infrared filters and a mid-infrared filter.

### Advantageous Effects of Invention

The rutile-type titanium oxide crystal of the present invention can be easily dispersed or mixed in a substance that exhibits no infrared absorption in the form of powder, and can also be easily dispersed in a liquid substance. Since the rutile-type titanium oxide crystal of the present invention efficiently transmits infrared rays in a wavelength range of 5 to 12 μm, a dispersion product obtained by dispersing the rutile-type titanium oxide crystal can be suitably used as a material for mid-infrared filters.

Since the production method of the present invention includes a step of sandwiching a compound containing a transition metal ion to be used for doping between nano crystals of titania with a nano-scale spatial distance (a step of obtaining a composite having a layered structure), titanium oxide can be effectively doped, in a uniform manner, with the transition metal ion confined in a nano-scale space by completely performing calcination in the air atmosphere. Herein, multiple types of atoms can be simultaneously used for doping, instead of a single type of atom. The doping conducted by this method is advantageous to the control of a fine structure, and the transmission wavelength of infrared rays can be controlled in a significantly narrow range. Therefore, the material for mid-infrared filters described above is provided.

### BRIEF DESCRIPTION OF DRAWINGS

FIG. 1 shows an XRD pattern of a precursor sample before calcination prepared in Example 1.

FIG. 2 shows an XRD pattern of a sample obtained by calcining the precursor at 800° C. in Example 1.

FIG. 3 shows an FT-IR transmission spectrum measured using a KBr plate containing 5% of titanium oxide obtained in Example 1.

FIG. 4 shows FT-IR transmission spectra measured using KBr plates containing 1% of titanium oxide and 15% of titanium oxide obtained in Example 1.

FIG. 5 shows an FT-IR transmission spectrum of titanium oxide in Example 2.

FIG. 6 shows an FT-IR transmission spectrum of titanium oxide doped with iron in Example 3.

FIG. 7 shows an FT-IR transmission spectrum of a polyethylene/titanium oxide blended film in Example 5.

FIG. 8 shows an FT-IR transmission spectrum of titanium oxide obtained in Comparative Example 1.

### DESCRIPTION OF EMBODIMENTS

A method for producing a rutile-type titanium oxide crystal of the present invention is characterized as follows. A composite including a titania nanocrystal and a complex (y) of an amino group-containing basic polymer (x) and a transition metal ion, the titania nanocrystal and the complex (y) being layered with an interlayer distance of 1 to 3 nm, is used as a precursor. By calcining the composite, the composite is converted into a rutile-type titanium oxide crystal doped with the transition metal ion.

It is believed that nanostructures such as nanocrystals and nanospaces have a huge potential for the synthesis of novel functional materials as new nano-reaction fields, in addition to a function provided by the structure itself. In particular, in the case where a nano-layered structure in which a second component substance is confined between layers of a semiconductor crystal located at a nano-scale distance is formed, a chemical reaction can be caused between the surface of the semiconductor crystal and the substance that is present between the layers by various processing methods. That is, a layered nanospace can form a significantly advantageous nano-reaction field. In the present invention, from such a point of view, an optimum process performed by a two-step method including the synthesis of a precursor substance for performing doping in a nano-reaction field and the calcination of the substance has been developed.

The complex (y) of an amino group-containing basic polymer (x) and a transition metal ion functions as a catalyst for a hydrolytic condensation reaction of a water-soluble titanium compound (z). At the same time, the complex (y) forms an ion complex with a titania sol generated through the reaction while inducing deposition of the titania sol. As a result, a composite having a polymer metal complex/titania layered structure in which the polymer and the titania are alternately stacked is produced.

By calcining the polymer metal complex/titania composite having a layered structure, the transition metal ion in the complex (y) of the amino group-containing basic polymer (x) and the transition metal ion, the complex (y) being present between the crystal layers of titania, causes a doping reaction at the surface of a titania crystal. As a result, a rutile-type titanium oxide crystal is obtained, and thus conversion into doped titanium oxide that can transmit infrared rays in a mid-infrared wavelength range is achieved.

In the above-described production method, it is important to remove an organic component derived from the amino group-containing basic polymer (x). Therefore, the calcination needs to be performed in an air atmosphere. That is, it is essential to remove a carbon component and a nitrogen component derived from an organic component in the form of carbon dioxide gas and nitrogen oxide gas, respectively, by performing calcination in the air atmosphere.

To increase the transmittance at a particular wavelength in the mid-infrared region, the titanium oxide crystal needs to be a rutile-type titanium oxide crystal. To achieve this, the calcination temperature needs to be 650° C. or higher and is desirably set to be 650 to 1200° C. in terms of energy cost. The calcination temperature is preferably 750 to 950° C. to efficiently form a rutile crystal phase.

The calcination time can be suitably set in the range of 2 to 14 hours. In general, the temperature range and time can be suitably adjusted by preparing a temperature-increasing program in terms of energy cost and productivity.

The content of the transition metal ion in the rutile-type titanium oxide crystal is preferably 0.05 to 5% by mass. The content can be adjusted by controlling the content of the transition metal ion in the complex (y) of the amino group-containing basic polymer (x) and the transition metal ion at the preparation stage of the composite serving as a precursor. That is, when the content is increased, the doping amount of transition metal ion is increased. When the content is decreased, the doping amount is decreased. By using a polymer complex including a different transition metal ion together, titanium oxide can be doped with multiple types of transition metal ions.

The obtained rutile-type titanium oxide crystal is normally in a powder form. By directly mixing the rutile-type titanium oxide crystal with various compounds or by mixing the rutile-type titanium oxide crystal pulverized in advance with various compounds, a molding material for mid-infrared filters can be obtained.

Raw materials used in the production method of the present invention will now be described.

[Polymer (x)]

The amino group-containing basic polymer (x) used in the present invention is not particularly limited, and typical water-soluble polyamines can be used.

Examples of a synthetic polyamine serving as the polymer (x) include synthetic polyamines having an amino group on its side chain or main chain, such as polyvinylamine, polyallylamine, polyethyleneimine (branched and straight chain), polypropyleneimine, poly(4-vinylpyridine), poly(aminoethyl methacrylate), and poly[4-(N,N-dimethylaminomethylstyrene)]. Among them, polyethyleneimine is particularly preferred because it is easily available and can easily form a layered structure with a titanium oxide sol.

Examples of a biogenic polyamine include chitin, chitosan, spermidine, bis(3-aminopropyl)amine, homospermidine, and spermine. Examples of a biogenic polymer having a large number of basic amino acid residues include biogenic polyamines, e.g., synthetic polypeptides such as polylysine, polyhistidine, and polyarginine.

The polymer (x) may be a modified polyamine obtained by bonding some of amino groups in a polyamine to a non-amine polymer skeleton or a copolymer of a polyamine skeleton and a non-amine polymer skeleton. The modified polyamine and the copolymer can be easily produced by causing the amino group of the amino group-containing basic polymer (x) to react with a compound having a functional group that can easily react with an amine, such as an epoxy group, a halogen, a tosyl group, or an ester group.

The non-amine polymer skeleton may be hydrophilic or hydrophobic. Examples of a hydrophilic polymer skeleton include skeletons of polyethylene glycol, polymethyloxazoline, polyethyloxazoline, and polyacrylamide. Examples of a hydrophobic polymer skeleton include skeletons of epoxy resin, urethane resin, and polymethacrylate resin. In the case where the polymer (x) has a structural unit having no amino group, the ratio of the non-amine polymer skeleton in the total structural unit of the polymer (x) is preferably 50% or less by mass, more preferably 20% or less by mass, and particularly preferably 10% or less by mass to achieve good dispersion state of the polymer (x) in water and to effectively facilitate the hydrolysis or dehydration condensation reaction of a water-soluble titanium compound (z) described below.

The molecular weight of the polymer (x) is not particularly limited. The weight-average molecular weight, which is a polystyrene equivalent value determined by gel permeation chromatography (GPC), is normally 300 to 100000, preferably 500 to 80000, and more preferably 1000 to 50000.

### [Complex (y) of Polymer/Transition Metal Ion]

The complex (y), of the amino group-containing basic polymer (x) and the transition metal ion, used in the production method of the present invention is obtained by adding a transition metal ion to the amino group-containing basic polymer (x). The complex (y) is formed through a coordinate bond between the transition metal ion and the amino group in the polymer (x).

The transition metal ion used herein is the same transition metal ion in the rutile-type titanium oxide crystal to be obtained, and any transition metal ion that can form a coordinate bond with an amino group can be used. In terms of the ionic valence of the transition metal ion, monovalent to tetravalent metal salts may be used, and the metal salts can be preferably used even in the complex ion state. Among them, an ion of iron, zinc, manganese, copper, cobalt, vanadium, tungsten, or nickel is preferably used because such an ion is easily available and provides a rutile-type titanium oxide crystal having high transmittance of mid-infrared rays.

The amount of the transition metal ion used is preferably 1/10 to 1/500 equivalents on an ion basis relative to the number of moles of the amino group in the amino group-containing basic polymer (x).

[Water-Soluble Titanium Compound (z)]

The titanium compound used in the present invention is soluble in water, and does not hydrolyze when being dissolved in water. That is, the titanium compound is preferably a non-halogen titanium compound that is stable in pure water. Specific examples of the titanium compound include an aqueous titanium bis(ammonium lactato)dihydroxide solution, an aqueous titanium bis(lactate) solution, a propanol/water mixed solution of titanium bis(lactate), and titanium(ethyl acetoacetate)diisopropoxide.

### [Composite Having Polymer/Titania Layered Structure]

The composite having a polymer/titania layered structure can be produced by adding the water-soluble titanium compound (z) to an aqueous solution of the complex (y) of the amino group-containing basic polymer (x) and the metal ion.

When the amount of the water-soluble titanium compound (z) serving as a titanium source is excessively large relative to the amine unit in the complex (y) of the amino group-containing basic polymer (x) and the metal ion, the composite can be suitably formed. Specifically, the amount of the water-soluble titanium compound (z) is 2 to 1000 times and preferably 4 to 700 times the equivalent amount of the amine unit.

The concentration of the aqueous solution of the complex (y) of the amino group-containing basic polymer (x) and the transition metal ion is preferably 0.1 to 30% by mass based on the amount of the polyamine contained in the polymer (x).

The time required for the hydrolytic condensation reaction of the water-soluble titanium compound (z) can be set in the range from one minute to several hours. The reaction time is preferably set in the range from 30 minutes to 5 hours to increase the reaction efficiency.

The pH value of the aqueous solution in the hydrolytic condensation reaction is preferably set in the range of 5 to 11 and is particularly preferably set in the range of 7 to 10.

A composite obtained through the hydrolytic condensation reaction in the presence of the complex (y) of the amino group-containing basic polymer (x) and the transition metal ion is a colored precipitate having a color of the transition metal ion.

The content of titania in the composite (precursor) produced through the hydrolytic condensation reaction can be adjusted by controlling the reaction conditions or the like, and a composite containing 20 to 90% by mass of titania can be obtained. The thus-obtained composite is calcined by the above-described method, whereby the rutile-type titanium oxide crystal of the present invention can be produced.

The rutile-type titanium oxide crystal of the present invention is a rutile-type titanium oxide crystal that is doped with a transition metal ion and that exhibits a transmitting property in a wavelength range of 5 to 12 μm, which is a mid-infrared region. The form is powder and the crystal is a polycrystal composed of crystals with a size of 20 to 100 nm.

The doping amount of the transition metal ion into the titanium oxide is normally 0.05 to 10% by mass and preferably 0.1 to 2% by mass to further decrease the half-width of an infrared transmission peak.

One or more types of transition metal ions may be used for doping. The half-width of a transmission peak and the height of the peak can be adjusted by controlling a mixed doping state.

In the present invention, a rutile-type crystal is an essential factor to provide the transmitting property in a wavelength range of 5 to 12 μm, which is a mid-infrared region. A complete rutile-type crystal phase is desired as a crystal phase. However, even if the titanium oxide crystal contains a certain amount of anatase crystal phase, it can be used for mid-infrared filters. In this case, the ratio of the anatase crystal phase is preferably 30% or less by mass.

The powder of the rutile-type titanium oxide crystal of the present invention can be lightly colored in accordance with the doping amount of transition metal ion and the type of transition metal ion.

The particle size of the powder is normally several micrometers, but can be easily adjusted to 100 nm or less by a pulverizing/dispersion method that uses a mill, Despa, or a mortar. By using powder having a small particle size for infrared filters, light scattering is suppressed and thus the transparency of the filters can be improved.

The rutile-type titanium oxide crystal of the present invention has a property of transmitting mid-infrared rays in a wavelength range of 5 to 12 μm. By adding a small amount of the titanium oxide to KBr, the wavenumber of an infrared transmission peak can be finely adjusted to, for example, 1037, 1055, 1057, 1068, 1096, or 1130 cm⁻¹. Furthermore, the half-width of the transmission peak is 2.5 μm or less.

When the rutile-type titanium oxide crystal of the present invention is used for mid-infrared filters, preferably, the rutile-type titanium oxide crystal is mixed with a polyolefin that does not absorb infrared rays in the mid-infrared region to prepare a molding material, and then the molding material is molded into a desired filter shape.

Examples of the polyolefin include industrially available polymers such as polyethylene, polypropylene, poly(ethylene/propylene), modified polyethylene, and modified polypropylene; and industrially available random copolymers and block copolymers of the foregoing. They may be used alone or in combination.

A method for producing the molding material containing the polyolefin and the rutile-type titanium oxide crystal is not particularly limited. The molding material can be produced with a commonly used melt-kneading machine such as a biaxial kneading machine or a Banbury mixer.

The melt-kneading temperature is not particularly limited as long as the pyrolysis of the polyolefin is prevented. The melt-kneading temperature is preferably 10 to 400° C. and particularly preferably 80 to 400° C.

The mixing ratio of the polyolefin and the rutile-type titanium oxide crystal is not particularly limited. The content of the rutile-type titanium oxide crystal in the entire molding material is normally 30% or less by mass. The content is preferably 5% or less by mass to improve the transparency and to increase the transmittance. Even if the content is such a low value, the molded product can be suitably used for mid-infrared filters.

The mid-infrared filters can be processed into a pellet, a film, a plate, a pipe, or the like. The mid-infrared filters can be pasted on other materials.

### EXAMPLES

The present invention will now be further described in detail. Note that “%” and “part” represent “% by mass” and “part by mass”, respectively, unless otherwise specified.

### [Analysis of Titanium Oxide by X-Ray Diffraction (XRD)]

Titanium oxide was placed on a sample holder and the sample holder was set in Wide-angle X-ray Diffractometer “Rint-ultma” manufactured by Rigaku Corporation. The measurement was performed using a Cu/Kα X-ray at 40 kV/30 mA at a scanning speed of 1.0°/min in a scanning range of 20 to 40°. In particular, in the detailed analysis of the internal structure of a coated film, the measurement was performed using a Cu/Kα X-ray at 50 kV/300 mA at a scanning speed of 0.12°/min with a scanning axis of 2θ (incident angle: 0.2 to 0.5°, 1.0°).

### [Infrared Transmission Spectrum]

Infrared transmission was measured using Fourier transform infrared spectrometer “Spectrum One Image System FT-IR Spectrometer” manufactured by PerkinElmer, Inc.

### [X-Ray Fluorescence Analysis]

X-ray fluorescence analysis was performed under the vacuum condition using ZSX manufactured by Rigaku Corporation.

### Example 1

### Synthesis of 1-Ti—Mn 500 Doped with Manganese Ion

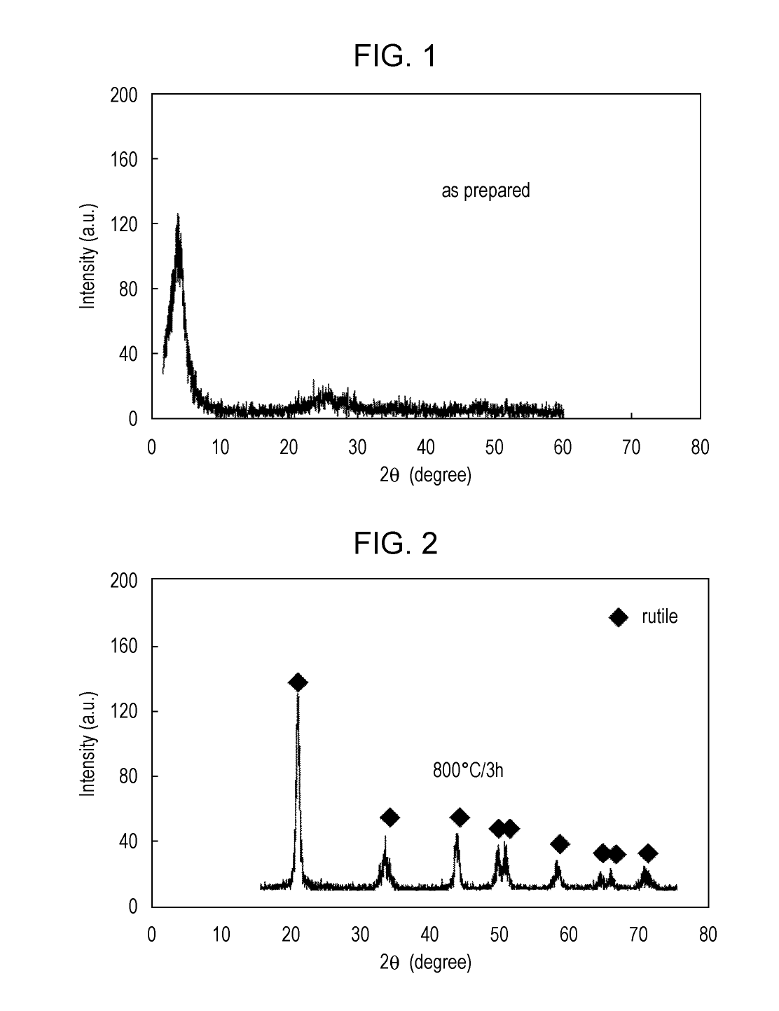

To prepare a complex solution of polyethylimine/manganese ion (A solution, molar ratio of imine/Mn: 500), 0.93 ml of 0.1 M Mn(NO₃)₂ was added to 100 ml of 2 wt % polyethylimine (SP 200 manufactured by NIPPON SHOKUBAI CO., LTD., molecular weight: 10000). In addition, 28% ammonia water was added dropwise to a titanium lactate solution (TC 310 manufactured by Matsumoto Pharmaceutical Manufacture Co., Ltd., 20 vol %) to prepare an aqueous solution (B solution) having a pH of 9. Ten milliliters of A solution was slowly added dropwise to 100 ml of B solution at room temperature (25° C.) under stirring. After about one hour, a large amount of precipitate was produced from the mixed solution. The precipitate was filtered, washed with water, and then dried at room temperature to obtain 8.2 g of light yellow powder (precursor). In the XRD pattern of the precursor powder, a strong X-ray diffraction peak that indicates a layered structure appeared on the low angle side (2θ, about 3.8°) (FIG. 1). In other words, the precursor was a composite having a layered structure that was formed from titanium oxide and a polymer metal complex.

Three grams of the precursor was inserted into an alumina crucible and calcined in the air atmosphere at 800° C. for 3 hours. Consequently, yellow powder (1-Ti—Mn 500) was obtained. The presence of a crystal phase that agrees with a rutile structure of titanium oxide was confirmed from the X-ray diffraction pattern of the powder (FIG. 2). As a result of the ultimate analysis using fluorescence X-rays, it was confirmed that 0.23% of MnO (0.18% in terms of manganese ion) was contained in 1-Ti—Mn 500. This means that titanium oxide obtained by performing calcination in the air atmosphere was doped with a manganese ion.

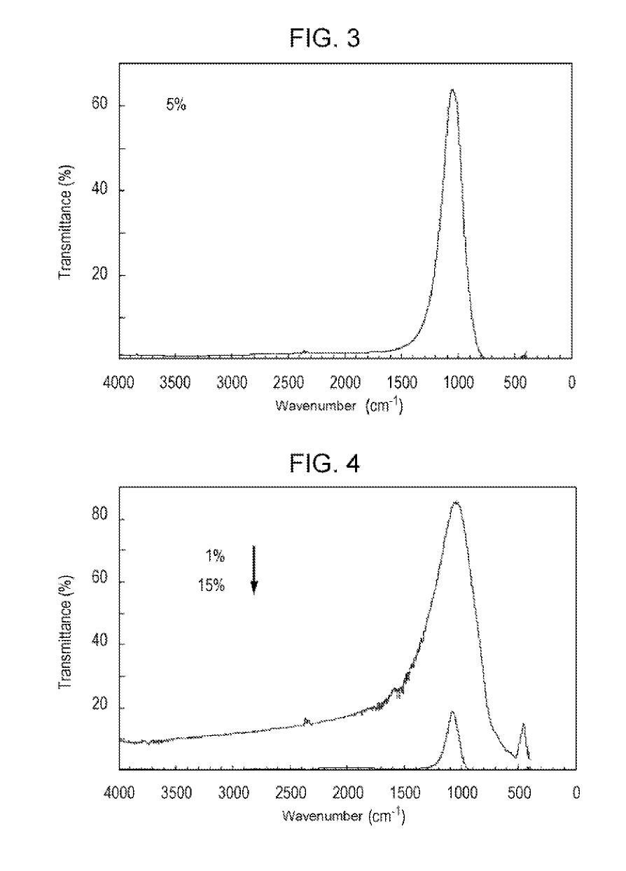

The 1-Ti—Mn 500 powder was mixed with KBr powder at percentages of 1, 5, and 15%. Each of the mixtures was ground using a mortar, and then a KBr plate was prepared. The plate was used for FT-IR measurement. FIGS. 3 and 4 show the FT-IR transmission spectra thereof. In the plate containing 5 wt % of 1-Ti—Mn 500 powder in KBr, infrared rays were cut on near-infrared and far-infrared sides, and the IR transmitting property was seen only in a particular wavenumber range of mid-infrared rays (wavelength: 6.8 to 13 μm). The transmittance of infrared rays at a center wavelength (9.71 μm) of the transmission peak was 64%. The half-width (the width at half of a peak maximum) of the peak was 1.97 μm. When the percentage of the 1-Ti—Mn 500 in the plate was increased (15%), the transmittance of infrared rays at a transmission peak was significantly low. When the percentage was decreased (1%), the transmission peak of infrared rays was broadened to a near-infrared region (FIG. 4). This clearly means that a plate containing a proper amount of 1-Ti—Mn 500 functions as an infrared filter that efficiently transmits mid-infrared rays.

### Example 2

### Synthesis of Titanium Oxide Doped with Manganese Ion, 2-Ti—Mn 500

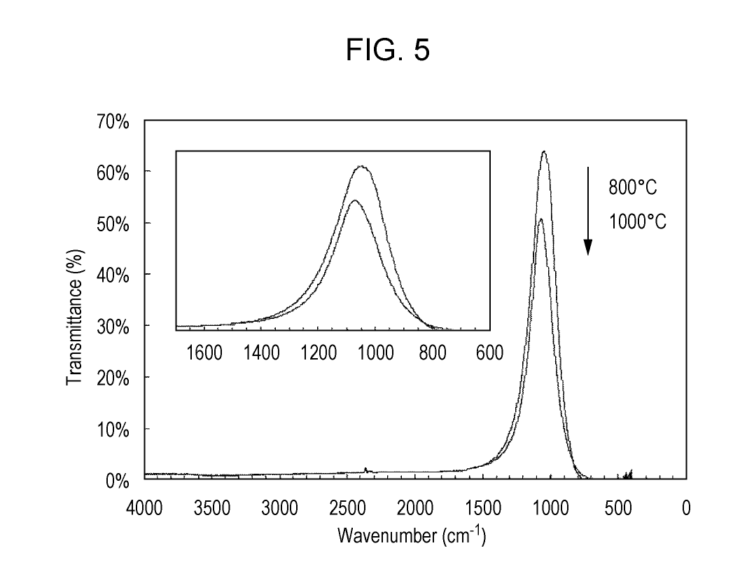

By the same method as in Example 1, 2-Ti—Mn 500 was prepared, except that the calcination temperature was changed to 1100° C. FIG. 5 shows the FT-IR spectrum of a plate prepared by mixing the sample (5%) with KBr through grinding. By increasing the calcination temperature, the transmission peak top of infrared rays showed a tendency to slightly shift to the shorter wavelengths. The center wavelength was 9.46 nm, the half-width was 1.89, and the transmittance was 50%.

### Example 3

### Synthesis of Titanium Oxide Doped with Iron Ion

A rutile-type titanium oxide doped with an iron ion was obtained by performing the synthesis of a precursor and calcination in the air atmosphere (800° C.) under the same conditions as in Example 1, except that Fe(NO₃)₂ (in the polymer metal complex, the molar ratio of ethyleneimine/iron was 1/25, 1/200, and 1/500) was used instead of Mn(NO₃)₂ in Example 1. Table 1 shows three titanium oxides having different doping amounts (the iron ion content is an equivalent value on a Fe₂O₃ basis).

TABLE 1

| | Sample name | | |
|---|---|---|---|
| | Ti—Fe | Ti—Fe | Ti—Fe |
| | 25 | 200 | 500 |
| Iron ion content measured by X-ray | 3.71 | 0.48 | 0.19 |
| fluorescence analysis (%) | | | |

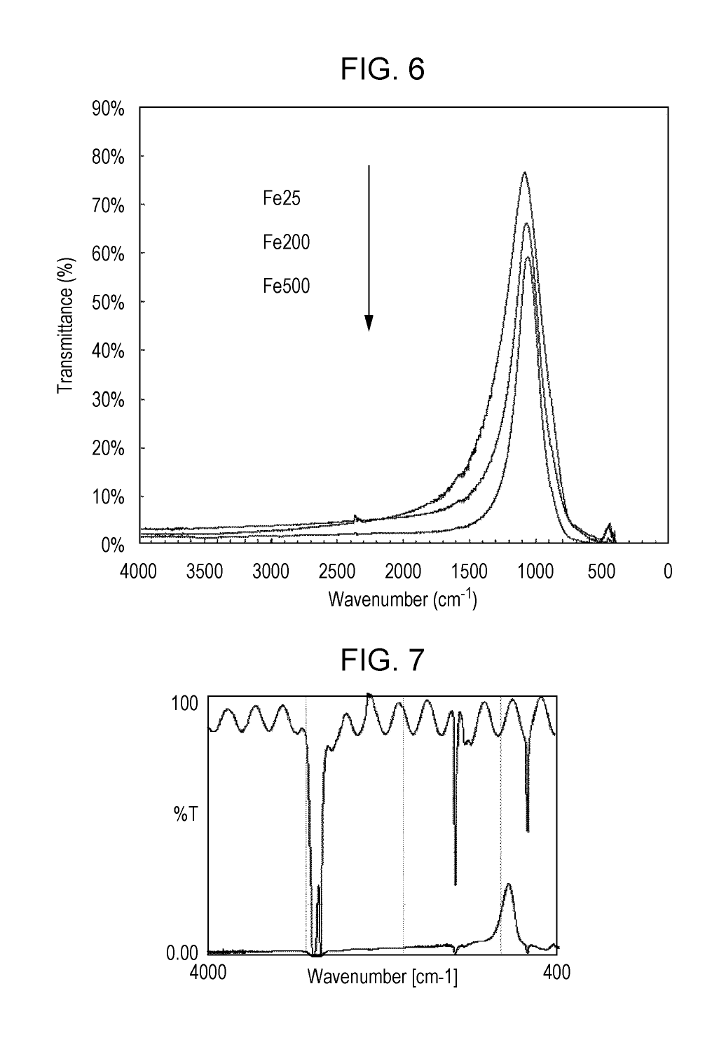

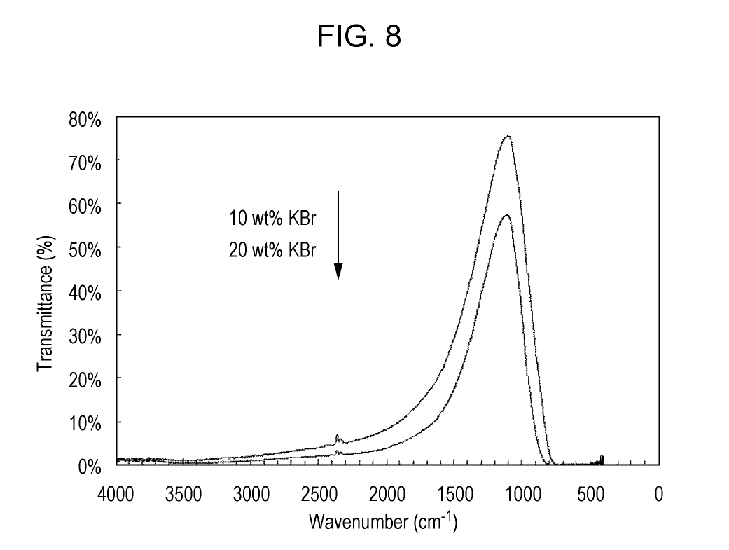

It was confirmed from XRD measurement that these three titanium oxide crystals were crystals that agree with a rutile structure. FIG. 6 shows the FT-IR spectrum of each of the samples (5% in KBr). As the doping amount of Fe increased, the transmittance of infrared rays tended to increase while at the same time the transmission peak width broadened.

### Example 4

### Synthesis of Titanium Oxide Doped with Tungsten Ion

A rutile-type titanium oxide doped with a tungsten ion was obtained by performing the synthesis of a precursor and calcination in the air atmosphere (800° C.) under the same conditions as in Example 1, except that ammonium tungstate (in the polymer metal complex, the molar ratio of ethyleneimine/tungsten was 1/25, 1/100, 1/200, and 1/500) was used instead of manganese nitrate in Example 1. Table 2 shows four titanium oxides having different doping amounts of tungsten (the tungsten ion content is an equivalent value on a W₂O₅ basis).

TABLE 2

| | Sample name | | | |
|---|---|---|---|---|
| | Ti—W | Ti—W | Ti—W | Ti—W |
| | 25 | 100 | 200 | 500 |
| Tungsten ion content measured | 4.79 | 1.00 | 0.71 | 0.31 |
| by X-ray fluorescence analysis (%) | | | | |
| Center wavelength (μm) | 8.88 | 8.93 | 8.94 | 9.42 |
| Half-width | 1.74 | 1.93 | 1.69 | 2.23 |
| Transmittance (%) | 57 | 54 | 50 | 52 |

It was confirmed from XRD measurement that these four titanium oxide crystals were crystals that agree with a rutile structure. It was also confirmed that, as the doping amount of tungsten increased, the center wavelength of the infrared transmission peak tended to slightly shift to the shorter wavelengths while the half-width tended to decrease.

### Example 5

### Infrared Filter Film Composed of Blend of Polyethylene and 1-Ti—Mn 500

After 90 parts of polyethylene and 10 parts of 1-Ti—Mn 500 were mixed with each other, the mixture was inserted into a biaxial kneading machine (KZW15TW-45MG-NH-700 manufactured by TECHNOVEL CORPORATION) and melt-kneaded under heating at 250° C. for 15 minutes. After the completion of the kneading, the blended sample was taken out of a kneading chamber and cooled and solidified by being sandwiched between two iron plates. Then, the sample was molded into a film having a thickness of about 2 mm.

FIG. 7 shows the FT-IR transmission spectrum of the film. A film composed of only polyethylene had absorption at about 2800 cm⁻¹, 1500 cm⁻¹, and 670 cm⁻¹, but no infrared absorption occurred in the wavenumber range except for the above wavenumbers and infrared rays were transmitted. In the case of the blended film, such absorption was cut and a transmission peak appeared at a wavenumber of 905 cm⁻¹. In other words, a blended polymer film containing manganese-doped rutile-type titanium oxide functions as an infrared transmission filter.

### Comparative Example 1

One milliliter of 0.1 M manganese nitrate was added to 10 ml of a dehydrated ethanol solution of 20 vol % titanium (IV) tetrabutoxide [Ti(OBu)₄], and the reaction was caused to proceed under stirring at room temperature for one hour. The precipitate was washed with water and dried at room temperature. The dried powder was calcined in the air atmosphere at 800° C. for 3 hours. It was confirmed from XRD measurement that the calcined titanium oxide had a rutile crystal structure. From X-ray fluorescence analysis, 0.76% of MnO was detected in the titanium oxide.

A KBr plate containing 10% of the sample was prepared in the same manner, and the FT-IR transmission spectrum of the KBr plate was measured. Infrared rays having a wavenumber higher than 1500 cm⁻¹ could not be cut and the transmission of infrared rays occurred in a wide wavelength range. As a result, transmitting property with wavelength selectivity was not satisfied. Even a KBr plate containing 20% of the sample was not suitable for infrared transmission filters.

1. A method for producing a rutile-type titanium oxide crystal doped with a transition metal ion, the method comprising:
a step (I) of dispersing or dissolving a complex (y) of an amino group-containing basic polymer (x) and a transition metal ion in an aqueous medium;
a step (II) of obtaining a composite having a polymer/titania layered structure in which the complex (y) of the amino group-containing basic polymer (x) and the transition metal ion is sandwiched between layers of titania with a distance of 1 to 3 nm, by mixing the aqueous dispersion or aqueous solution prepared in the step (I) with a water-soluble titanium compound (z) in the aqueous medium at a temperature of 50° C. or lower to cause a hydrolysis reaction; and
a step (III) of calcining the composite having the layered structure in an air atmosphere at a temperature of 650° C. or higher to dope a surface of a titanium oxide crystal with the transition metal ion confined in the layered structure and simultaneously to cause growth into a rutile-type crystal phase.

2. The method for producing a rutile-type titanium oxide crystal according to claim 1, wherein the transition metal ion is an ion of at least one transition metal selected from the group consisting of iron, zinc, manganese, copper, cobalt, vanadium, tungsten, and nickel.

3. A rutile-type titanium oxide crystal doped with a transition metal ion, wherein the crystal exhibits a transmitting property in a range of 5 to 12 μm of an infrared spectrum, and a half-width of a transmission peak is 2.5 μm or less.

4. The rutile-type titanium oxide crystal according to claim 3, wherein the transition metal ion is an ion of at least one transition metal selected from the group consisting of iron, zinc, manganese, copper, cobalt, vanadium, tungsten, and nickel.

5. The rutile-type titanium oxide crystal according to claim 3, wherein a content of the transition metal ion is 0.01 to 10% by mass.

6. A powder for mid-infrared filters, comprising the rutile-type titanium oxide crystal according to claim 3.

7. A molding material for mid-infrared filters, comprising the rutile-type titanium oxide crystal according to claim 3 and a polyolefin.

8. A molding material for mid-infrared filters, comprising
the rutile-type titanium oxide crystal according to claim 4 and a polyolefin.

9. (canceled)

10. A powder for mid-infrared filters, comprising the rutile-type titanium oxide crystal according to claim 4.

11. The rutile-type titanium oxide crystal according to claim 4, wherein a content of the transition metal ion is 0.01 to 10% by mass.
